(19) United States
(12) Patent Application Publication
(10) Pub. No.: US 2011/0154475 A1
(43) Pub. Date: Jun. 23, 2011

(54) MODEM AND METHOD FOR CONSERVING POWER CONSUMPTION OF AN ELECTRONIC DEVICE

(75) Inventor: WEI-CHENG WU, Tu-Cheng (TW)

(73) Assignee: FOXCONN COMMUNICATION TECHNOLOGY CORP., Taoyuan County (TW)

(21) Appl. No.: 12/730,262

(22) Filed: Mar. 24, 2010

(30) Foreign Application Priority Data
Dec. 17, 2009 (CN) 200910311699.2

(51) Int. Cl. G06F 21/20; G06F 1/32

(52) U.S. Cl. 726/13; 713/324

(57) ABSTRACT

A modem and method for conserving power of an electronic device includes storing a black list and a white list, each of the black list and the white list including one or more Internet Protocol (IP) addresses. The modem and method further includes receiving a packet from an IP address, determining if the IP address is in the black list or the white list, dropping the packet if the IP address is in the black list, or resetting the timer and sending the packet to the electronic device if the IP address is in the white list.

### BACKGROUND

1. Technical Field

Embodiments of the present disclosure relate to power management, and more particularly to a modem and a method for conserving power consumption of an electronic device.

2. Description of Related Art

A local electronic device may connect with remote electronic devices, such as remote computers or mobile phones, through a modem and a network. If the remote electronic devices send various packets to the local electronic device to establish different kinds of connections (e.g., a transfer control protocol connection), efficiency of the local electronic device suffers. If the TCP packets include vicious packets, the local electronic device has to consume more power to process the vicious packets.

What is needed, therefore, is a modem and a method for conserving power of an electronic device.

### BRIEF DESCRIPTION OF THE DRAWINGS

FIG. 1 is a block diagram of one embodiment of a modem in communication with an electronic device.

FIG. 2 is a block diagram of one embodiment of the modem of FIG. 1.

FIG. 3A and FIG. 3B are flowcharts of a first embodiment of a method for conserving power consumption of an electronic device using the modem of FIG. 1.

FIG. 4 is a flowchart of a second embodiment of a method for conserving power consumption of an electronic device using the modem of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

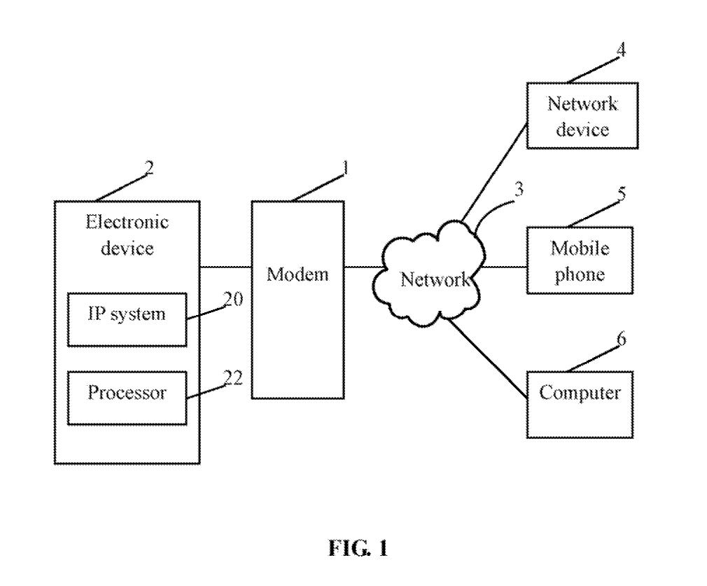

FIG. 1 is a block diagram of one embodiment of a modem 1 in communication with an electronic device 2. The electronic device 2 may connect to a plurality of remote devices through the modem 1 and a network 3. In one embodiment, the modem 1 may be used to conserve the power of the electronic device 2 by filtering packets sent from the remote device. If the packets are sent from a reliable remote computer, the modem sends the packets to the electronic device 2 to process. Otherwise, if the packets are sent from an unreliable remote computer, the modem may drop the packets without sending the packets to the electronic device 2, so the electronic device 2 does not need to consume power to process redundant packets. For example, a remote computer that communicates with the electronic device 2 frequently and transfers useful packets between with the electronic device 2 may be regarded as a reliable remote computer. A remote computer that sends vicious packets to the electronic device 2 may be regarded as an unreliable remote computer.

The electronic device 2 may be a mobile phone, a computer, a personal digital assistant, a palmtop computer, or any other kind of computing device. The electronic device 2 includes an Internet Protocol (IP) system 20 and a processor 22. The IP system 20 may help the electronic device 2 connect with the remote devices. In one embodiment, the remote device may be network devices 4, mobile phones 5, or computers 6, for example. The network 3 may be the Internet, or a communication network, for example.

The modem 1 may be internal equipment of the electronic device 2, or peripheral that connects to the electronic device 2. In one embodiment, if the electronic device 2 is a mobile phone, the modem 1 can be included in the mobile phone. In another embodiment, if the electronic device 2 is a computer, the modem 1 can be a peripheral connects to the computer.

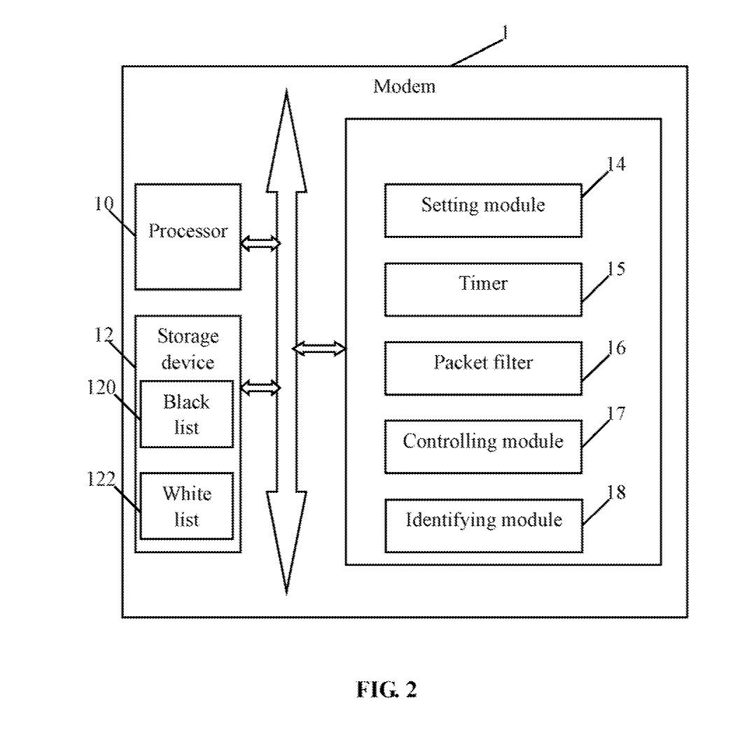

FIG. 2 is a block diagram of one embodiment of the modem 1 of FIG. 1. The modem includes a processor 10 and a storage device 12. The processor 10 executes one or more computerized operations of the modem 1 and other applications, to provide the functions of the modem 1. The storage device 12 stores one or more programs of the modem 1, and various kinds of data, such as a black list and a white list including one or more IP addresses, for example. In one embodiment, the black list is a list of IP addresses that are disallowed from establishing connections with the electronic device 2. For example, a blacklisted IP address may be 10.12.81.201. Similarly, the white list is a list of IP addresses that are allowed from establishing connections with the electronic device. In one embodiment, the storage device 12 may be a memory of the modem 1.

In one embodiment, the modem 1 includes a setting module 14, a timer 15, a packet filter 16, a controlling module 17, and an identifying module 18. The modules 14-18 may comprise one or more computerized codes to be executed by the processor 10 to perform one or more operations of the modem 1. Details of these operations will be provided below.

The setting module 14 may be used to preset a time interval to control the electronic device 1 to enter into a sleep state. In one embodiment, during the time interval, if the electronic device 2 does not receive or send any packets, the modem 1 may control the electronic device 2 to enter into the sleep state to conserve the power of the electronic device 2. The time interval may be set at 5 minutes, for example.

In one embodiment, the setting module 14 may also be used to set data in the black list 120 and the white list 122. For example, the black list 120 and the white list 122 may have data that includes one or more IP addresses, port numbers, or protocol numbers of the remote devices. The data in the black list 120 and the white list 122 may be newly added, modified, or deleted using the setting module 14. In another embodiment, the data in the black list 120 and the white list 122 may also be set using the IP system 20 of the electronic device 2.

The timer 15 starts timing when the modem 1 is powered on.

The packet filter 16 receives a packet from an IP address of a remote device, and determines if the IP address is in the black list or the white list. If the IP address is in the black list, the packet filter 16 drops the packet. If the IP address is in the white list, the packet filter 16 resets the timer and sends the packet to the electronic device 2.

The packet filter 16 further resets the timer 15 to restart timing if the electronic device 2 sends out a packet through the modem 1.

The controlling module 17 determines if the time interval has been reached, and controls the electronic device 2 to enter into the sleep state if the time interval has been reached. In one embodiment, the sleep state controlled by the modem 1 does not conflict with other sleep states controlled by an operating system of the electronic device 2, such as a standby state, for example. In one embodiment, if the controlling module of the modem 1 controls the electronic device 2 to enter into the sleep state, and then a user begins to operate the electronic device 2, the electronic device 2 switches from the sleep state to a working state.

If the IP address is not in the black list or the white list, the identifying module 18 identifies if the packet is a vicious packet according to predetermined criterions. The predetermined criterions may be set by the setting module 14 according to user requirements, such as a remote device sending packets to the modem 1 continuously to ask for a connection (e.g., a TCP connection) with the electronic device 2, for example. However, after the connection is established, the remote device has not sent any packets. Thus, the remote device may be regarded as an attacker, and the packets sent from the remote device may be regarded as vicious packets.

If the packet is a vicious packet, the packet filter 16 drops the packet, and the setting module 14 stores the IP address into the black list 120. If the packet is not a vicious packet, the packet filter 16 sends the packet to the electronic device 2 and resets the timer 15 to restart timing.

As mentioned above, the black list 120 and the white list 122 also include port numbers or protocol numbers of some remote devices. According to similar procedures, the packet filter 16 also determines if a port number or a protocol number of a remote device is in the black list or the white list, and then determines if it needs to drop the packet or send the packet to the electronic device 2.

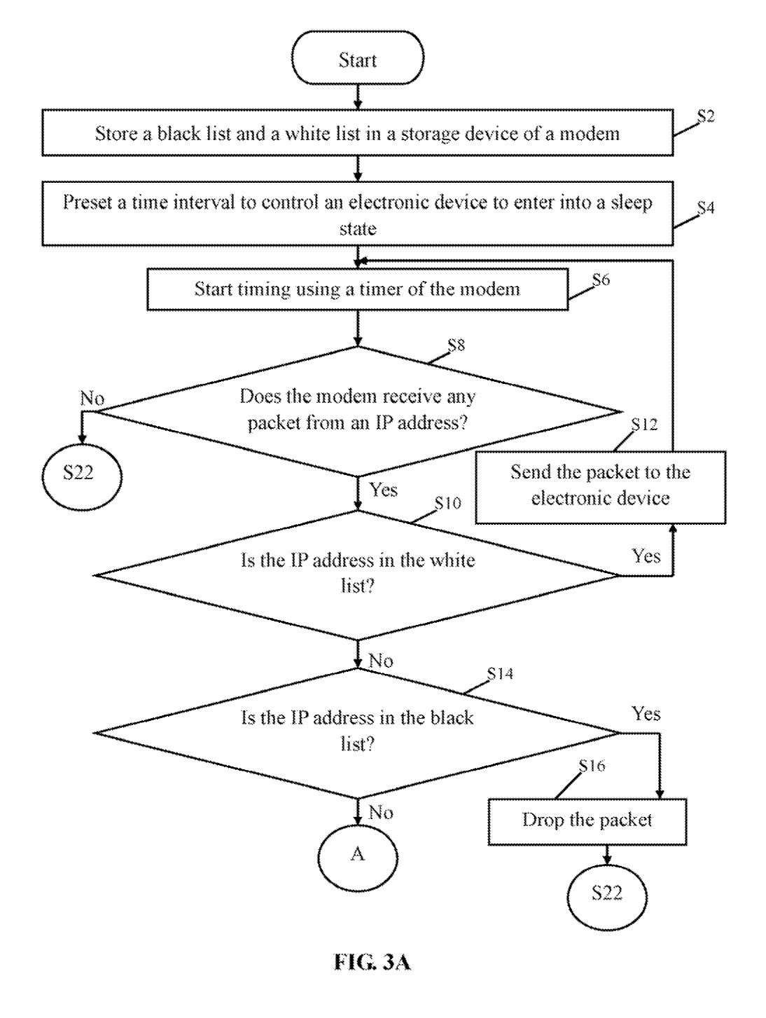

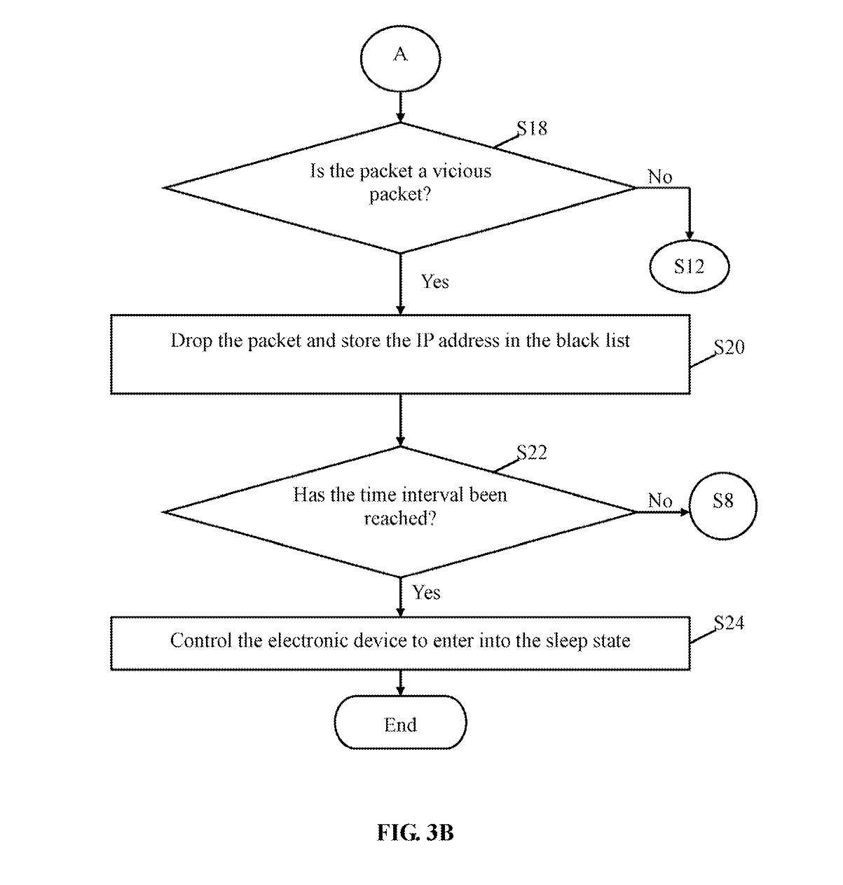

FIG. 3A and FIG. 3B are flowcharts of a first embodiment of a method for conserving power consumption of the electronic device 2 using the modem 1 of FIG. 1. Depending on the embodiment, additional blocks may be added, others removed, and the ordering of the blocks may be replaced.

In block S2, the storage device 12 stores a black list 120 and a white list 122. As mentioned above, the black list 120 and the white list 122 include one or more IP addresses, port numbers, or protocol numbers of remote devices. The data in the black list 120 and the white list 122 may be newly added, modified, or deleted using the setting module 14.

In block S4, the setting module 14 presets a time interval to control the electronic device 1 to enter into a sleep state. As mentioned above, during the time interval, if the electronic device 2 does not receive or send any packets, the modem 1 may control the electronic device 2 to enter into the sleep state to conserve the power of the electronic device 2.

In block S6, the timer 15 starts timing when the modem 1 is powered on.

In block S8, the packet filter 16 determines if the modem receives any packets from an IP address of a remote device. If the packet filter 16 does not receive any packets, the procedure goes to block S22 directly. If the packet filter 16 receives a packet from an IP address of a remote device, in block S10, the packet filter 16 determines if the IP address is in the white list.

If the IP address is in the white list, in block S12, the packet filter sends the packet to the electronic device 2, and then the procedure returns to block S6 to restart timing.

If the IP address is not in the white list, in block S14, the packet filter determines if the IP address is in the black list. If the IP address is in the black list, in block S16, the packet filter drops the packet, and then the procedure goes to block S22 directly.

If the IP address is not in the black list, in block S18, the identifying module 18 identifies if the packet is a vicious packet according to predetermined criterions. As mentioned above, if a remote device sends packets to the modem 1 continually to ask for a connection with the electronic device 2. However, after the connection is established, the remote device does not send any more packets. The remote device may be regarded as an attacker, and the packets sent from the remote device may be regarded as the vicious packets. If the packet is not a vicious packet, the procedure returns to block S12.

If the packet is a vicious packet, in block S20, the packet filter 16 drops the packet, and the setting module 14 stores the IP address into the black list 120.

In block S22, the controlling module 17 determines if the time interval has been reached. If the time interval has been reached, in block S24, the controlling module 17 controls the electronic device 2 to enter into the sleep state. If the time interval has not been reached, the procedure returns to block S8.

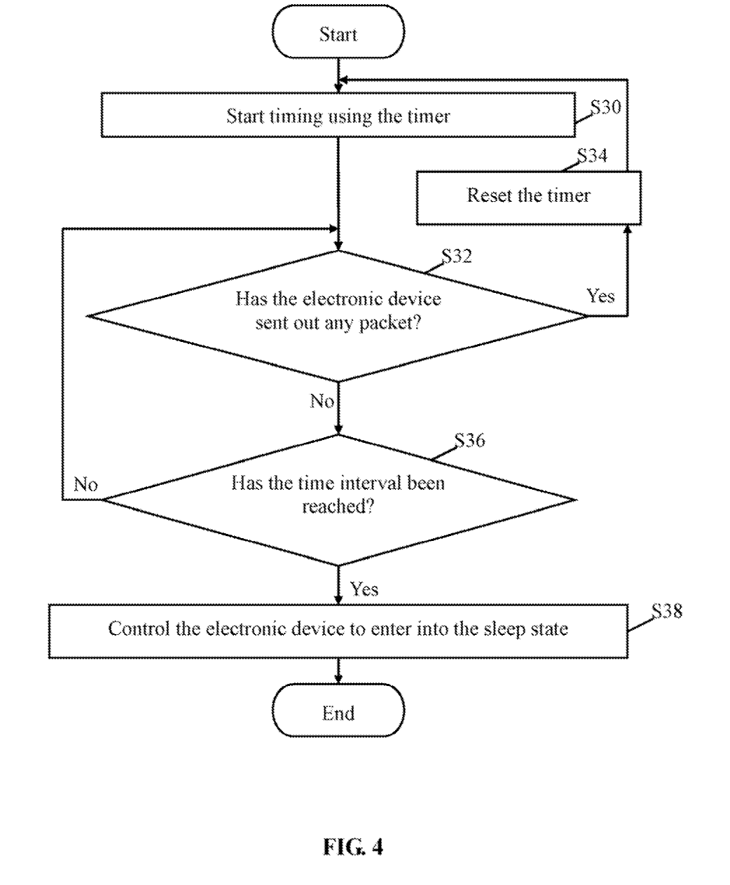

FIG. 4 is a flowchart of a second embodiment of a method for conserving power consumption of the electronic device 2 using the modem 1 of FIG. 1. Depending on the embodiment, additional blocks may be added, others removed, and the ordering of the blocks may be replaced.

In block S30, the timer 15 starts to time when the modem 1 is powered on.

In block S32, the packet filter 16 determines if the electronic device 2 has sent out any packets through the modem 1. If the electronic device 2 has sent out the packets through the modem 1, in block S34, the packet filter 16 resets the timer 15, and then the procedure returns to block S30 to restart timing.

If the electronic device 2 has not sent out any packets, in block S36, the controlling module 17 determines if the time interval has been reached. If the time interval has been reached, in block S38, the controlling module 17 controls the electronic device 2 to enter into the sleep state. If the time interval has not been reached, the procedure returns to block S32.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for conserving power consumption of an electronic device, the electronic device in communication with a modem, the method comprising:
storing a black list and a white list in a storage device of the modem, each of the black list and the white list comprising one or more Internet Protocol (IP) addresses;
presetting a time interval to control the electronic device to enter into a sleep state;
starting timing using a timer of the modem when the modem is powered on;
receiving a packet from an IP address;
determining if the IP address is in the black list or the white list;
dropping the packet if the IP address is in the black list, or resetting the timer and sending the packet to the electronic device if the IP address is in the white list; and
controlling the electronic device to enter into the sleep state if the time interval has been reached.

2. The method according to claim 1, further comprising:
identifying if the packet is a vicious packet if the IP address is not in the black list or the white list;
storing the IP address into the black list if the packet is the vicious packet; or
sending the packet to the electronic device, resetting the timer, and returning to the step of starting timing using the timer of the modem, if the packet is not the vicious packet.

3. The method according to claim 1, further comprising:
resetting the timer, and returning to the step of starting timing using the timer of the modem, if the electronic device sends out a packet through the modem.

4. The method according to claim 1, wherein each of the black list and the white list further comprises port numbers and protocol numbers.

5. The method according to claim 4, further comprising:
determining if a port number is in the black list or the white list in response to receiving a packet from the port number; and
dropping the packet if the port number is in the black list, or resetting the timer and sending the packet to the electronic device if the port number is in the white list.

6. The method according to claim 1, wherein the modem is an internal equipment or an external equipment of the electronic device, and the electronic device is a mobile phone, a personal digital assistant, or a palm.

7. A modem capable of conserving power consumption of an electronic device, the modem in communication with the electronic device, the modem comprising:
a storage device for storing a black list and a white list, each of the black list and the white list comprising one or more Internet Protocol (IP) addresses;
at least one processor; and
one or more programs stored in the storage device and being executable by the at least one processor, the one or more programs comprising:
a setting module operable to preset a time interval to control the electronic device to enter into a sleep state;
a timer operable to start timing when the modem is powered on;
a packet filter operable to receive a packet from an IP address, determine if the IP address is in the black list or the white list, drop the packet if the IP address is in the black list, or reset the timer and send the packet to the electronic device if the IP address is in the white list; and
a controlling module operable to control the electronic device to enter into the sleep state if the time interval has been reached.

8. The modem according to claim 7, wherein the one or more programs further comprise an identifying module operable to identify if the packet is a vicious packet if the IP address is not in the black list or the white list, store the IP address into the black list if the packet is the vicious packet, or send the packet to the electronic device and reset the timer to restart timing if the packet is not the vicious packet.

9. The modem according to claim 7, wherein the packet filter is further operable to reset the timer to restart timing if the electronic device sends out a packet through the modem.

10. The modem according to claim 7, wherein each of the black list and the white list further comprises port numbers and protocol numbers.

11. The modem according to claim 10, wherein the packet filter is further operable to determine if a port number is in the black list or the white list in response to receiving a packet from the port number, drop the packet if the port number is in the black list, or reset the timer and send the packet to the electronic device if the port number is in the white list.

12. The modem according to claim 7, wherein the modem is an internal equipment or an external equipment of the electronic device, and the electronic device is a mobile phone, a personal digital assistant, or a palm.

13. A storage medium storing a set of instructions, the set of instructions capable of being executed by a processor to perform a method for conserving power consumption of an electronic device, the electronic device in communication with a modem, the method comprising:
storing a black list and a white list in a storage device of the modem, each of the black list and the white list comprising one or more Internet Protocol (IP) addresses;
presetting a time interval to control the electronic device to enter into a sleep state;
starting timing using a timer of the modem when the modem is powered on;
receiving a packet from an IP address;
determining if the IP address is in the black list or the white list;
dropping the packet if the IP address is in the black list, or resetting the timer and sending the packet to the electronic device if the IP address is in the white list; and
controlling the electronic device to enter into the sleep state if the time interval has been reached.

14. The storage medium as claimed in claim 13, wherein the method further comprises:
identifying if the packet is a vicious packet if the IP address is not in the black list or the white list;
storing the IP address into the black list if the packet is the vicious packet; or
sending the packet to the electronic device, resetting the timer, and returning to the step of starting timing using the timer of the modem, if the packet is not the vicious packet.

15. The storage medium as claimed in claim 13, wherein the method further comprises:
resetting the timer, and returning to the step of starting timing using the timer of the modem, if the electronic device sends out a packet through the modem.

16. The storage medium as claimed in claim 13, wherein each of the black list and the white list further comprises port numbers and protocol numbers.

17. The storage medium as claimed in claim 16, wherein the method further comprises:
determining if a port number is in the black list or the white list in response to receiving a packet from the port number; and
dropping the packet if the port number is in the black list, or resetting the timer and sending the packet to the electronic device if the port number is in the white list.

18. The storage medium as claimed in claim 13, wherein the modem is an internal equipment or an external equipment of the electronic device, and the electronic device is a mobile phone, a personal digital assistant, or a palm.
